(19) United States
(12) Patent Application Publication
(10) Pub. No.: US 2006/0204934 A1
(43) Pub. Date: Sep. 14, 2006

(54) Gutta percha tip and method for producing the same

(76) Inventors: Werner Mannschedel, Langenau (DE); Barbara Muller, Langenau (DE)

Correspondence Address: EDWARDS & ANGELL, LLP, P.O. BOX 55874, BOSTON, MA, 02205, US

(21) Appl. No.: 11/357,000

(22) Filed: Feb. 17, 2006

Related U.S. Application Data
(63) Continuation of application No. PCT/EP04/09320, filed on Aug. 19, 2004.

(30) Foreign Application Priority Data
Aug. 19, 2003 (DE) DE 103 38 440.5

(51) Int. Cl. A61C 5/02; A61G 5/02

(52) U.S. Cl. 433/224; 433/81

(57) ABSTRACT

The present invention is concerned with a gutta-percha point for filling a tooth root canal system, which is characterised in that in that it has at least one portion having a cross-sectional area with a non-circular circumference and in that the surface of the gutta-percha point has a different roughness in different sections.

This application is a continuation of International Application PCT/EP2004/009320 having an International filing date of Aug. 19, 2004, which is incorporated herein by reference in its entirety.

The present invention is concerned with the field of aids for dentistry and relates to a gutta-percha point for filling a tooth root canal system. The invention relates furthermore to methods for the manufacture of gutta-percha points.

In root canal treatment, it desirable to effect a best possible hermetic seal using a filling material that does not irritate the tissue. An ideal root canal filling material should not irritate the periapical tissue, should tightly occlude the root canal laterally and vertically, its volume should remain stable and it should not shrink in the root canal. Furthermore, it should not encourage bacterial growth, should be as bacteriostatic as possible but at the same time be biologically compatible and non-toxic.

It has been shown that root canal filling using gutta-percha points and a sealer is biologically the best and, in the long term, the safest method. A distinguishing feature of a gutta-percha point is the thermoplastic deformability of the material, which enables it to be worked well under gentle heat, for example, at body temperature, i.e. 37° C., and consequently permits an especially reliable filling of a root canal. Usually, such a gutta-percha point has a gutta-percha content of about 20% by weight ±10% by weight. This differentiates a gutta-percha tip or a gutta-percha point from a retention pin or post that consists of a solid material, such as, for example, a metal or a metal alloy and is anchored in a tooth cavity, for example in the upper two thirds of a root canal, in order to fix dental prostheses, such as crowns or bridges for example. Widely used methods for introducing gutta-percha into the root canal are lateral condensation, vertical condensation, thermomechanical condensation and also injection techniques.

In the commonly used method of lateral condensation, root canal filling commences with the selection of a gutta-percha master point, which is introduced first into the root canal. A second gutta-percha point is then introduced into the root canal and is deformed by means of a hook-shaped tool, known as a spreader, and condensed with the master point. This process is repeated until a homogeneous root canal filling is achieved. Excess coronal gutta-percha point is subsequently removed. Owing to the poor sealing properties of gutta-percha, for hermetic sealing of the root canal it is essential to use an additional sealer, which is applied, for example, to the surface of the gutta-percha points.

It has been shown that in particular in the case of the above-described technique of lateral condensation, it may happen that deformation of the gutta-percha point by the spreader can often not be effected satisfactorily, because the gutta-percha points, which are round in cross-section, elude deformation by the manually guided spreader. This means that a satisfactory lateral condensation and homogeneous filling of the root canal cannot always be ensured. That is, an ideal end result of the root canal filling can be achieved only with a comparatively large amount of time and not least assumes a corresponding dexterity of the operator.

With conventional methods for filling the root canal system using gutta-percha points, in particular the technique of lateral condensation, to avoid irritation of the periapical tissue by filling material it is often indicated to prepare what is called an apical stop, that is, to create a defined end to the usually conical canal configuration. Complete filling of the root canal with gutta-percha can often be done only with difficulty, owing to the small available space.

Furthermore, with the customary methods of introducing gutta-percha into the root canal, trapped air or excess sealer can give rise to significant problems, which can mean that the outcome of the root canal treatment is not as successful as desired. When using customary gutta-percha points, there is also no guarantee that sufficient sealer will be introduced into the dentine tubules to ensure a complete occlusion and as a result prevent the ingress of fluids and germs.

Compared with this, the object of the present invention is to make available gutta-percha points with which the above-mentioned problems can be eliminated or mitigated.

Gutta-percha points are known per se and can be obtained commercially in a variety of forms. In the present invention, the term “gutta-percha point” or “gutta-percha tip” means in particular a point or a tip for filling a tooth root canal system and comprising gutta-percha, gutta-percha being a known natural substance on a polyisoprene basis obtained from tree resins. Apart from gutta-percha, the gutta-percha point or gutta-percha tip (hereinafter called gutta-percha point) can contain customary additives, for example, inorganic substances, such as, for example, inorganic fillers, such as zinc oxide, X-ray contrast agents such as heavy metal salts, especially barium sulphate, or organic substances, such as waxes, for example. Normally, a gutta-percha point contains approximately 70% by weight of ZnO, approximately 10% by weight of BaSO₄ and approximately 1-4% by weight of waxes.

In accordance with a first embodiment of the invention, a gutta-percha point for filling a tooth root canal system is provided, which is characterised in that at least one protrusion is formed on the surface of the gutta-percha point. Such a protrusion is advantageously in the form of a barb, a bump or lug or a circumferential ring. This prevents the gutta-percha points, for example, from rolling out of position when the tooth root canal system is being filled. Since the protrusions deform on contact with the root canal wall, and establish a two-dimensional contact with it, a larger contact surface is thus provided, which prevents accidental movement or even dislodgement of the gutta-percha point from the root canal. Customary gutta-percha points have the disadvantage that they make poor contact with the root canal and with the sealer. Thus, with customary gutta-percha points it may happen that manipulations at the coronal end of a gutta-percha point inserted in a root canal, for example to shorten the point or filling for the insertion of a post, cause the gutta-percha point in the root canal to move or become dislodged therefrom. A protrusion improves the bond between gutta-percha point and sealer and between gutta-percha point and dentine in an advantageous manner. What is more, through a given thickness of the protrusion, a desired thickness of the sealer layer can be set. A sealer can also be transported further into the root canal by the protrusions and be condensed in the root canal, which not only leads to an advantageous filling up of the root canal but also to displacement of the sealer into dentine tubules, the effect being that these are advantageously occluded, especially with respect to liquids and germs. Furthermore, a wedging, bracing or jamming of a plurality of gutta-percha points in the root canal is facilitated by at least one protrusion formed on the surface of each individual point, which also advantageously improves fixing of the points in the root canal.

It is furthermore advantageous that such a protrusion is in the form of a helical winding. In particular, this ensures that the gutta-percha point is fixed in the root canal, because the helical windings are distorted and create a large contact area with the root canal wall.

Preferably, a plurality of identical or different protrusions is provided at the same time on the surface of a gutta-percha point according to the invention. Several protrusions on the surface of a gutta-percha point can also have different sizes or strengths. Preferably, the relative size or strength of a plurality of protrusions on the surface of a gutta-percha point changes along the longitudinal axis thereof, that is to say, towards the apical end and the coronal end of the gutta-percha point. In this manner, a gutta-percha point can have, for example, a relatively thin circumferential ring in the apical region, a thicker ring in a middle region and an even thicker ring in the coronal region.

In a second advantageous embodiment of the gutta-percha point of the present invention, it has at least one portion having a cross-sectional area with a non-round (non-circular) circumference. In other words, the gutta-percha point has at least one portion of a non-round cross-section by which the rolling property of the gutta-percha point is eliminated or at least reduced. The expression “cross-sectional area”, as used here, describes preferably a section through the gutta-percha point running perpendicularly to the direction of the point. According to a preferred embodiment, the gutta-percha point has an angular form.

In an especially advantageous construction of the second embodiment of the gutta-percha point of the invention, the gutta-percha point can comprise a plurality of portions in the direction of the point, at least one portion having a cross-sectional area having a circumferential form that differs from the circumferential form of the cross-sectional area of a different portion. Thus, the gutta-percha point can have, for example, apical cross-sectional areas of a circular cross-section. In a three-dimensional view, this can correspond to a conical form of the gutta-percha point in this region. Furthermore, the gutta-percha point can have coronal cross-sectional areas with a non-round, for example, angular, circumference. In this way, the rolling property of the gutta-percha points in the non-apical portions of the tooth root canal system, in which the volume of the cavity is relatively large, can advantageously be eliminated or at least reduced. The root canal itself is generally not of round cross-section, so that the effect of a filling using a gutta-percha point of non-round cross-section is that the root canal is advantageously filled up.

The terms “apical” and “coronal”, as used here, refer to the arrangement of the gutta-percha point in the tooth root canal system.

In a further exemplary embodiment, portions having cross-sectional areas with a round (circular) circumference and non-round (non-circular) circumference can be arranged alternately.

According to the invention, it is preferred if the circumference of the cross-sectional area is partially or completely in the form of a closed polyline, that is to say, straight lines connected to one another, which merge into one another at a knee point. The knee points between the straight lines correspond in the three-dimensional form to edges of the surface of the gutta-percha point extending in the direction of the point, and correspond to the corners of an angular circumference of the cross-sectional area of the gutta-percha point. Owing to the edges, such a construction of the gutta-percha point is especially advantageous to prevent the gutta-percha point from rolling out of position as the tooth root canal system is being filled, and allows a gutta-percha point to be fixed properly in the root canal. At the same time, the flat faces of such a construction of the gutta-percha point have the advantage that several points can be fixed especially well against one another with a large contact area, for example, in the case of lateral condensation. Furthermore, the flat faces allow the space of the root canal to be properly filled by the gutta-percha points, since two gutta-percha points can be joined tightly with one another via a common coplanar, even face, that is, with no void between them. Such gutta-percha points can also be wedged, braced or jammed together especially effectively. A further advantage of large flat surfaces is that owing to greater friction they do not slide as readily past other surfaces as smaller surfaces do. Thus, it is more difficult for the gutta-percha points to slide past each other, which prevents undesirable slippage of points that have already been positioned. Furthermore, large surfaces have the advantage that they close well even without condensation, which is advantageous with regard to a good occlusion of the root canal.

In accordance with a third embodiment of the invention, which can be combined in particular with the first and/or second embodiment of the invention, the surface of the gutta-percha point has a different roughness in different portions to reduce the rolling properties of a gutta-percha point. The gutta-percha point can accordingly advantageously be less rough, for example, in the apical region of the tooth root canal system, than in the non-apical region of the tooth root canal system. To increase the roughness of the surface of the gutta-percha point, at least one, in particular pattern-form, three-dimensional structure can be formed on the surface of the gutta-percha point. Pattern-form three-dimensional structures are defined by regularly repeated structural elements, which are present, for example, in the form of depressions or bulges, whereas in the case of irregular three-dimensional structures the structural elements are arranged randomly. Such a three-dimensional structure to increase the roughness of the surface of the gutta-percha point is preferably present in the form of a honeycomb structure. Not only can the gutta-percha point be effectively prevented from rolling out of position by this means, but in addition the surface of the gutta-percha point can also be enlarged, so that condensation of the gutta-percha points is promoted. Furthermore, such a three-dimensional structure for increasing the roughness of the surface improves fixing of a gutta-percha point in the root canal, whereby in particular the master point can be apically fixed in order to ensure an advantageous occlusion of the root canal at the apex. Further advantages are evident for the wedging, bracing, jamming and/or interlocking, the effect being that gutta-percha points are fixed not only in the root canal but also against each another. A surface structure also advantageously renders it more difficult for several gutta-percha points to slide past one another or for a gutta-percha point to shift in the root canal. The bond between gutta-percha point and sealer is likewise advantageously improved by a three-dimensional surface structure.

In accordance with a fourth embodiment of the invention, which can be combined in particular with the first, second and/or third embodiment of the invention, the gutta-percha point is provided in one direction, for example, parallel to the point direction, with at least one through-channel. Such a through-channel can run, for example, completely within the gutta-percha point; as an alternative to this, the through-channel can be in the form of a channelled recess in the surface of the filling point. Air and/or liquids, especially the sealer, are advantageously able to escape from the root canal system through such through-channels, so that possible complications owing to any air remaining in the root canal system or owing to excess sealer can be avoided. This contributes significantly to a positive treatment outcome.

Furthermore, it is consequently possible to use a quantity of sealer that ensures that the dentine tubules are completely and permanently occluded. Furthermore, overfilling with sealer is avoided in this way, so that in particular escape of the sealer from the apex can be prevented.

In accordance with a fifth embodiment of the invention, which can be combined in particular with the first, second, third and/or fourth embodiment of the invention, the gutta-percha point has on its surface at least one structure, especially running parallel to the direction of the point, such as a reinforcing rib to stiffen the gutta-percha point. Preferably, the structure is provided in the form of a reinforcing rib running parallel to the direction of the point. By means of such structures, introduction of a gutta-percha point into the tooth root canal system can be appreciably facilitated. Furthermore, such a structure advantageously improves both the rigidity and the strength of the gutta-percha point, whilst the plastic deformability of the gutta-percha point is maintained. Alternatively, the strength of the gutta-percha point can also be increased by incorporating a customary reinforcing material, for example, reinforced fibres of glass or carbon as well as polymers.

The gutta-percha point according to the invention can advantageously be manufactured by the casting, especially injection moulding, of liquid gutta-percha in a mould to produce a gutta-percha casting, and by subsequent solidification of the gutta-percha casting to produce the gutta-percha point. In this connection, it is especially preferred if the liquid gutta-percha is poured into a mould that is a negative impression of a positive impression of a tooth root canal system. In other words, first of all a cast is made of the tooth root canal system to produce the positive impression, for example, by introducing a silicone mass. Subsequently this positive impression is used to make a negative impression, that is to say, a hollow mould, which corresponds to the cavity of the tooth root canal system. The negative impression is then plugged with liquid gutta-percha and solidified to produce the gutta-percha point. The gutta-percha point has a shape complementary to the cavity of the tooth root system.

Alternatively, the gutta-percha point can be produced by a material-removing processing of a solid gutta-percha blank. For example, the gutta-percha point in this case is milled from a gutta-percha blank. In this connection, in an especially advantageous manner the cavity of the tooth root canal system was previously measured three-dimensionally in a suitable manner and the gutta-percha point is milled from the gutta-percha blank using this measurement data, so that, similarly to casting of the gutta-percha point by means of a negative impression, a gutta-percha point having a shape complementary to the cavity of the tooth root canal system is produced.

Furthermore, the gutta-percha point can be manufactured by a non-material-removing processing of a solid gutta-percha blank. For example, a gutta-percha blank is pressed using a suitable pressing tool to shape the gutta-percha point. This procedure very advantageously presents an opportunity to produce the gutta-percha points using different starting materials. Thus, for example, gutta-percha points can be manufactured having a surface of gutta-percha and a core of a material other than gutta-percha, especially flexible materials such as acrylates, silicones, polyethylenes, polypropylenes, metals, polyurethanes, thermoplastic elastomers, rubber-like compounds etc. In an especially advantageous manner, the cavity of the tooth root canal system in this case was previously measured three-dimensionally in a suitable manner and using this measurement data the gutta-percha point is pressed from the gutta-percha blank, so that, similar to casting of the gutta-percha point by means of a negative impression, a gutta-percha point having a shape complementary to the cavity of the tooth root canal system is produced by pressing.

Surprisingly, it was found that manufacture of a gutta-percha point with exactly defined three-dimensional surface structures and/or exactly defined protrusions is possible if such a structure and/or protrusion is either placed in the mould or applied subsequently.

### BRIEF DESCRIPTION OF THE FIGURES

FIG. 1 shows a preferred embodiment of the gutta-percha point according to the invention, which has a plurality of protrusions in the form of bumps.

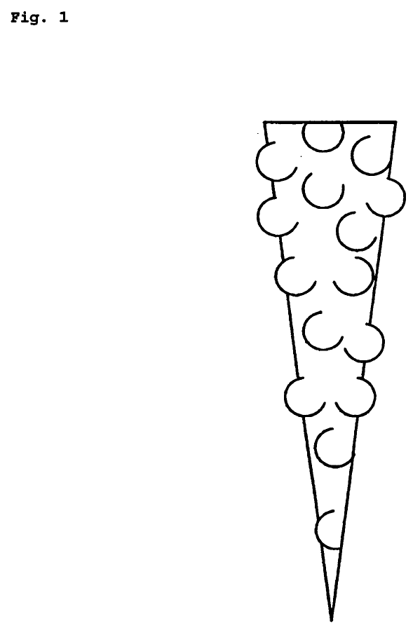

FIG. 2 shows a preferred embodiment of the gutta-percha point according to the invention, which has a plurality of protrusions in the form of barbs.

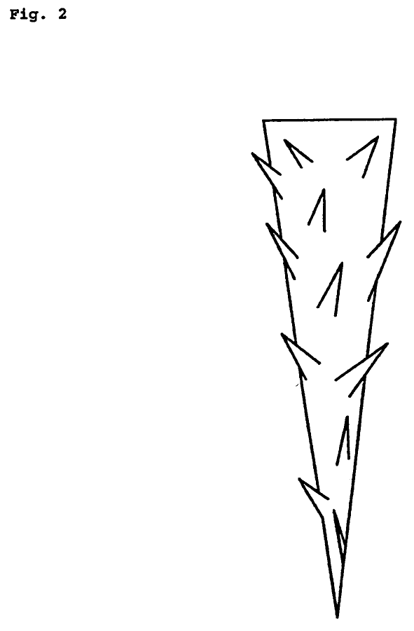

FIG. 3 shows a preferred embodiment of the gutta-percha point according to the invention, which has a plurality of protrusions in the form of lugs.

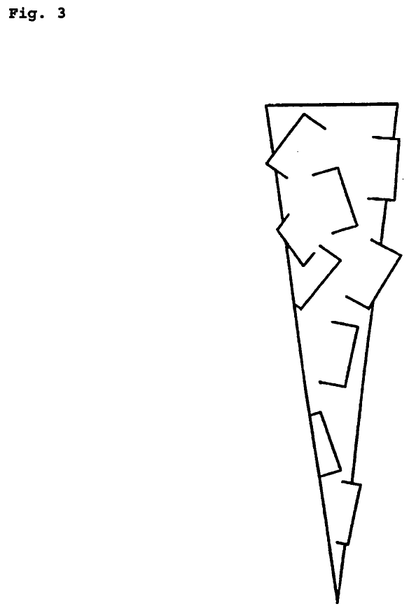

FIG. 4 shows a preferred embodiment of the gutta-percha point according to the invention, which has a plurality of protrusions in the form of circumferential rings having diameters that decrease in the apical direction.

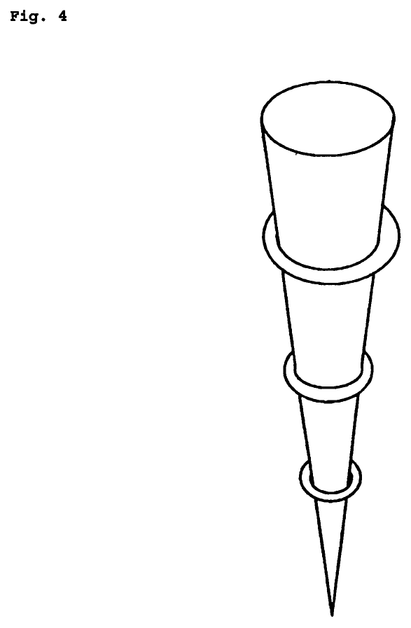

FIG. 5 shows a preferred embodiment of the gutta-percha point according to the invention, which has a protrusion in the form of a circumferential ring as well as a portion having a cross-sectional area with a round circumference and a portion having a cross-sectional area with a circumference in the form of a closed polyline.

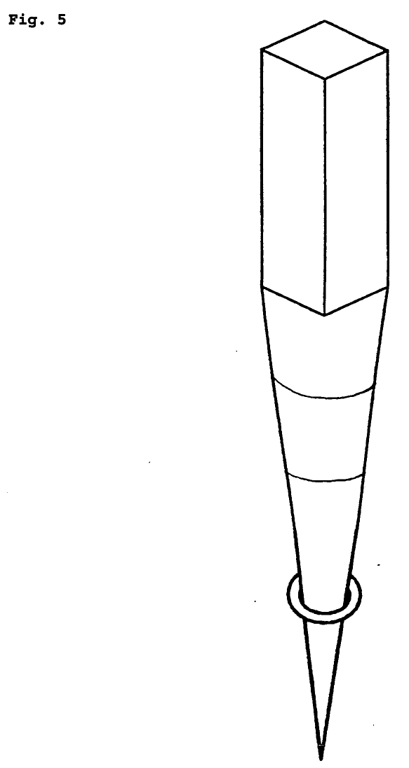

FIG. 6 shows a further preferred embodiment of the gutta-percha point according to the invention, which has a protrusion in the form of a circumferential ring as well as a portion having a cross-sectional area with a round circumference and a portion having a cross-sectional area with a circumference in the form of a closed polyline.

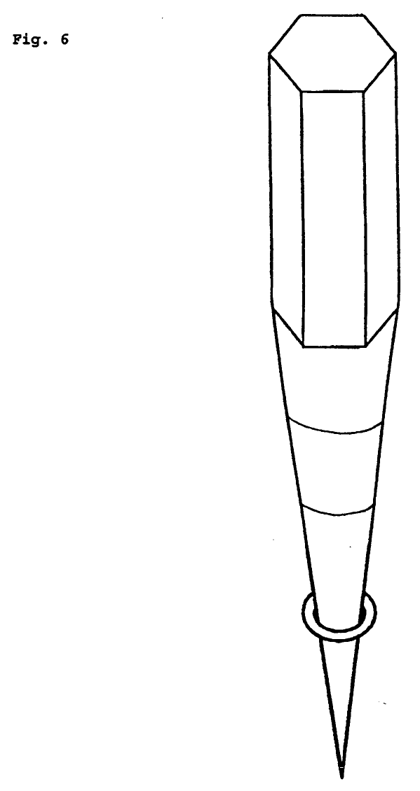

FIG. 7 shows a preferred embodiment of the gutta-percha point according to the invention, which has a protrusion in the form of a circumferential ring as well as two portions having a cross-sectional area with a round circumference and two portions having a cross-sectional area with a circumference in the form of a closed polyline.

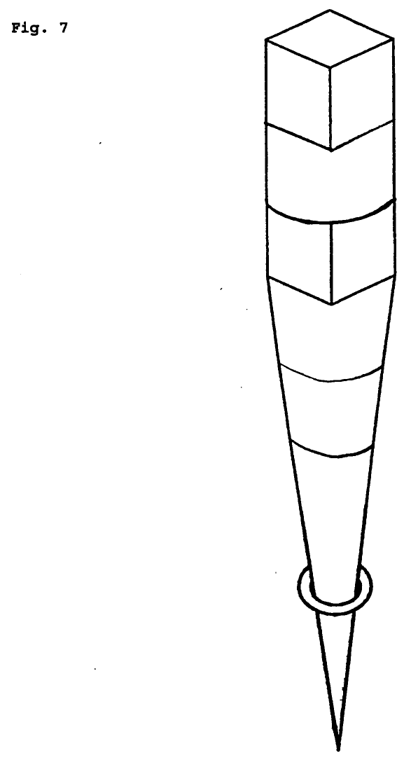

FIG. 8 shows a further preferred embodiment of the gutta-percha point according to the invention, which has a protrusion in the form of a circumferential ring as well as two portions having a cross-sectional area with a round circumference and two portions having a cross-sectional area with a circumference in the form of a closed polyline.

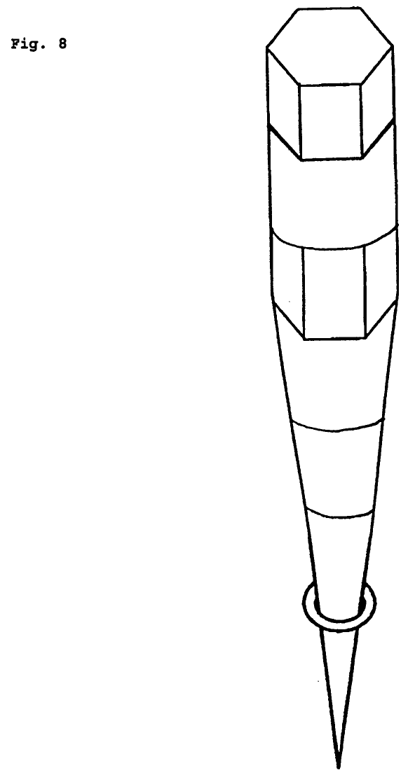

1-24. (canceled)

25. A gutta-percha point for filling a tooth root canal system comprising: at least one protrusion is formed on a surface of the gulta-percha point.

26. A gutta-percha point of claim 25 wherein the protrusion is constructed in the form of a barb, a bump or lug or a circumferential ring.

27. A gutta-percha point of claim 25 wherein the protrusion is constructed in the form of a helical winding.

28. A gutta-percha point of claim 25 wherein the gutta-percha point has at least one portion having a cross-sectional area with a non-round circumference.

29. A gutta-percha point of claim 25 wherein the gutta-percha point has a plurality of portions, at least one portion having a cross-sectional area with a circumferential form that is different from the circumferential form of the cross-sectional area of a different portion.

30. A gutta-percha point of claim 25 wherein a cross-sectional area with a non-round circumference has a circumference in the form of a closed polyline.

31. A gutta-percha point of claim 25 wherein the surface of the gutta-percha point has a different roughness in different portions.

32. A gutta-percha point of claim 31 wherein the surface of the gutta-percha point has at least one, especially pattern-form, three-dimensional structure.

33. A gutta-percha point of claim 31 wherein different portions the gutta-percha point have different three-dimensional structures.

34. A gutta-percha point of claim 31 wherein the three-dimensional structure is a honeycomb structure.

35. A gulta-percha point of claim 25 wherein the gutta-percha point comprises at least one channel in one direction.

36. A gutta-percha point of claim 35 wherein the at least one channel is parallel to the direction of the point.

37. A gutta-percha point of claim 35 wherein the channel is in the form of a channelled recess in the surface of the point.

38. A gutta-percha point of claim 25 wherein on the gutta-percha point has at least one structure, running in particular parallel to the direction of the point, for reinforcing the gutta-percha point.

39. A gutta-percha point of claim 25 wherein the cross-sectional area is cut perpendicularly to the direction of the point.

40. A method for the manufacture of a gutta-percha point for filling a tooth root canal system, comprising:
casting liquid gutta-percha in a mould to produce a gutta-percha casting; and
solidification of the gutta-percha casting to produce the gutta-percha point.

41. A method according to claim 40 wherein the liquid gutta-percha is cast in a mould which is a negative impression of a positive impression of a tooth root canal system.

42. The method of claim 40 wherein the liquid gutta-percha is injection moulded.

43. The method of claim 40 wherein the produced gutta-percha point comprises at least one protrusion on a surface of the gutta-percha point

44. A method for the manufacture of a gutta-percha point for filling a tooth root canal system, the method comprising material-removing of a solid gutta-percha blank to produce the gutta-percha point.

45. A method of claim 44 wherein the gutta-percha blank is milled.

46. A method of claim 44 wherein the tooth root canal system is measured three-dimensionally and the gutta-percha point is moulded in a mould corresponding to and complementary with the tooth root canal system.

47. A method of claim 44 wherein the produced gutta-percha point comprises at least one protrusion on a surface of the gutta-percha point.

48. A method for the manufacture of a gutta-percha point for filling a tooth root canal system, the method comprising non-material-removing of a solid gutta-percha blank to produce the gutta-percha point.

49. A method of claim 48 wherein the gutta-percha blank is pressed.

50. A method of claim 48 wherein a gutta-percha blank, which comprises gutta-percha and at least one material other than gutta-percha, is subjected to non-material-removing processing.

51. A method of claim 48 wherein the tooth root canal system is measured three-dimensionally and the gutta-percha point is moulded in a mould corresponding to and complementary with the tooth root canal system.

52. A method of claim 48 wherein the produced gutta-percha point comprises at least one protrusion on a surface of the gutta-percha point

53. A gutta-percha point manufactured by a method according to claim 40.

54. A gutta-percha point manufactured by a method according to claim 44.

55. A gutta-percha point manufactured by a method according to claim 48.
